(19) United States
(12) Patent Application Publication
(10) Pub. No.: US 2012/0241539 A1
(43) Pub. Date: Sep. 27, 2012

(54) PERCUSSIVE SPRINKLER WITH FLOW REGULATION FUNCTIONS

(76) Inventor: Cheng-An WANG, Lu Kang Town (TW)

(21) Appl. No.: 13/069,613

(22) Filed: Mar. 23, 2011

(51) Int. Cl. B05B 3/14

(52) U.S. Cl. 239/233

(57) ABSTRACT

A percussive sprinkler with flow regulation functions has a main body with an inlet tube coupling end, top frame, sprinkler head and flow channel. A percussive diversion frame is arranged onto the top frame. The diversion frame is provided with a hydraulic pusher and a torsional spring. The pusher is located correspondingly with a spacing to the front end of the sprinkler head. A regulating valve assembly portion is formed onto the preset location of the flow channel, and has a through-hole and inner wall. The through-hole is connected with the flow channel. A flow regulating valve is set on the regulating valve assembly portion, and has a switching member and a regulating portion. The switching member can be driven to control water flow via the rotation of the regulating portion. The users can change the water outflow for a variety of operating environments with improved applicability.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates generally to a percussive sprinkler, and more particularly to an innovative one which has flow regulation functions.

2. Description of Related Art Including Information Disclosed Under 37 CFR 1.97 and 37 CFR 1.98.

The common sprinkler for gardening applications (referred to as a percussive sprinkler that can be rotated automatically during water sprinkling) generally has amain body, inlet tube, top frame, diversion element and outlet tube. Of which, the outlet tube is located obliquely at one side of the sprinkler's main body, such that when water stream is guided from the inlet tube and sprayed from the outlet tube, a parabolic water column is formed due to oblique arrangement of the outlet tube, and automatic sprinkling is realized with the setting of diversion element.

Thus, to overcome the aforementioned problems of the prior art, it would be an advancement if the art to provide an improved structure that can significantly improve the efficacy.

Therefore, the inventor has provided the present invention of practicability after deliberate experimentation and evaluation based on years of experience in the production, development and design of related products.

### BRIEF SUMMARY OF THE INVENTION

The enhanced efficacy of the present invention is as follows:

Based on the unique construction of the present invention wherein “the percussive sprinkler with flow regulation functions” is provided with a flow regulating valve, the water outflow control system of the percussive sprinkler could be used to control the water outflow of the sprinkler by the regulating portion, enabling the users to change randomly the water outflow of the sprinkler for meeting a variety of operating environments with improved applicability.

### BRIEF DESCRIPTION OF THE SEVERAL VIEWS OF THE DRAWINGS

FIG. 1 is an exploded perspective view of the preferred embodiment of the present invention.

FIG. 2 is an assembled perspective view of the preferred embodiment of the present invention.

FIG. 3 is an assembled sectional view of the preferred embodiment of the present invention.

FIG. 4 is a schematic view of the flow regulating valve of the preferred embodiment of the present invention.

### DETAILED DESCRIPTION OF THE INVENTION

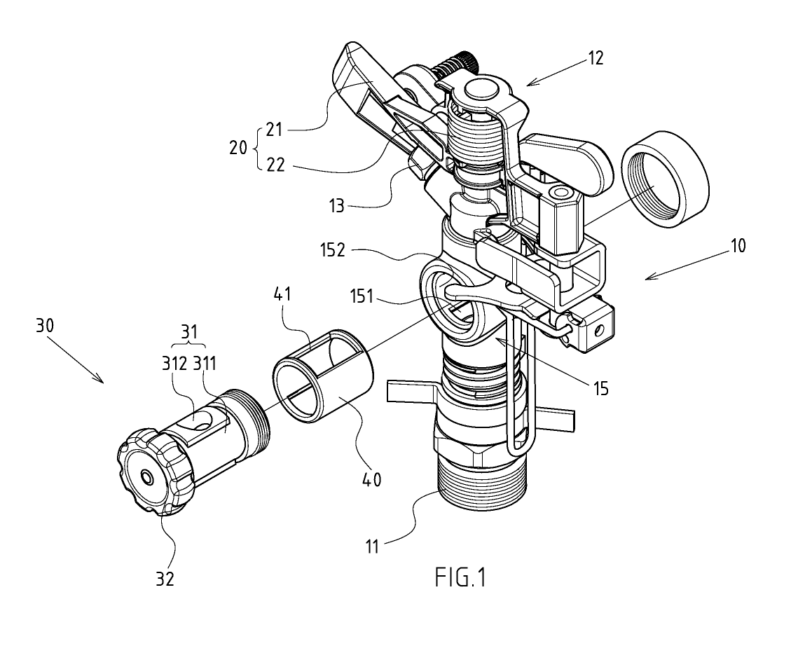

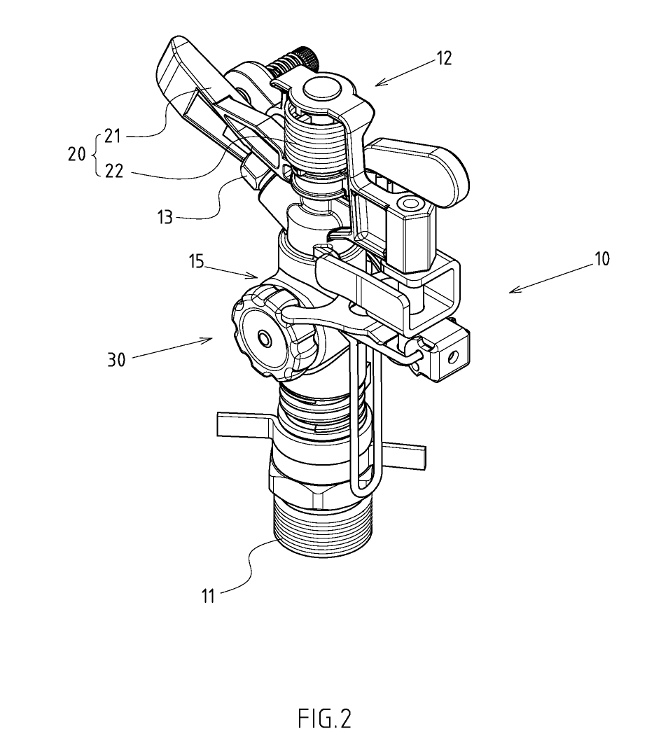

FIGS. 1-3 depict preferred embodiments of a percussive sprinkler of the present invention with flow regulation functions, which, however, are provided for only explanatory objective for patent claims.

Said percussive sprinkler has a main body 10, at lower end of which an inlet tube coupling end 11 is set, and at upper end of which a top frame 12 is set. A sprinkler head 13 is protruded forwards close to the lower flange of the top frame 12. A flow channel 14 is also formed between the inlet tube coupling end 11 and sprinkler head 13.

A percussive diversion frame 20 is arranged onto the top frame 12 at upper end of the main body 10. A hydraulic pusher 21 and a torsional spring 22 are arranged at one side of the percussive diversion frame 20. The hydraulic pusher 21 is located correspondingly with a spacing to the front end of the sprinkler head 13 of the main body 10.

A regulating valve assembly portion 15 is formed onto the preset location of the flow channel 14 of the main body 10, and includes a through-hole 151 and inner wall 152. Said through-hole 151 is connected with the flow channel 14.

A flow regulating valve 30 is assembled onto the regulating valve assembly portion 15, and has at least a switching member 31 and a regulating portion 32. The switching member 31 can be driven to control water flow or water cut-off state via the rotation of the regulating portion 32. The flow regulating valve 30 is configured into a cylinder shape that can be embedded into the regulating valve assembly portion 15.

Of which, a sealing valve seat 40 is arranged between the flow regulating valve 30 and regulating valve assembly portion 15 for the purpose of leakproofing. Said sealing valve seat 40 is provided with a penetrated hole 41 corresponding to the flow channel 14 for water circulation.

Of which, the switching member 31 includes a radial sleeve 311 and an axial water guide hole 312 formed on the radial sleeve 311. The regulating portion 32 is arranged at one side of the radial sleeve 311. When the regulating portion 32 is rotated, the axial water guide hole 312 on the radial sleeve 311 of said switching member 31 may be covered partially by the inner wall 152 of the regulating valve assembly portion 15, in tune with the rotation angle change of the flow regulating valve 30. As the axial water guide hole 312 is available with different diameters, it is possible to control the water outflow, or to stop water supply when the axial water guide hole 312 is fully covered by the inner wall 152 of the regulating valve assembly portion 15.

Based on the above-specified structural design, the present invention is operated as follows:

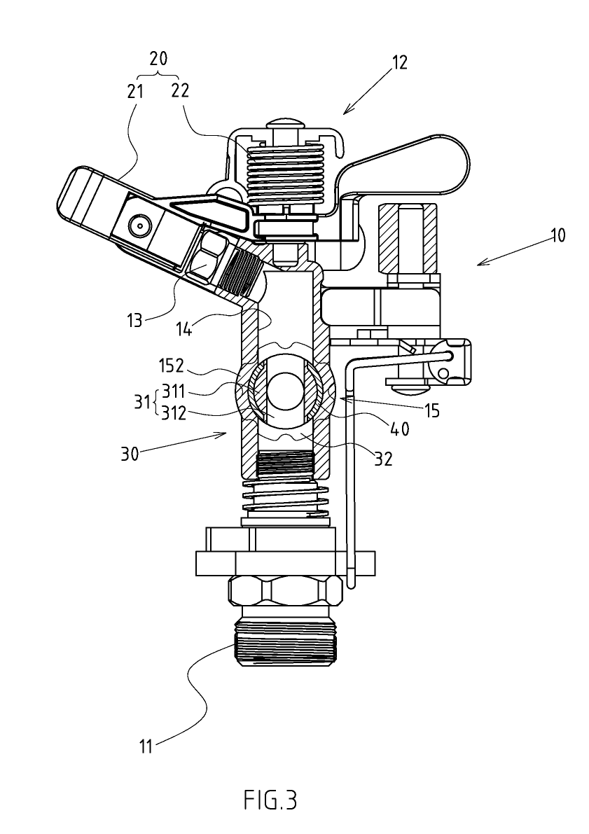

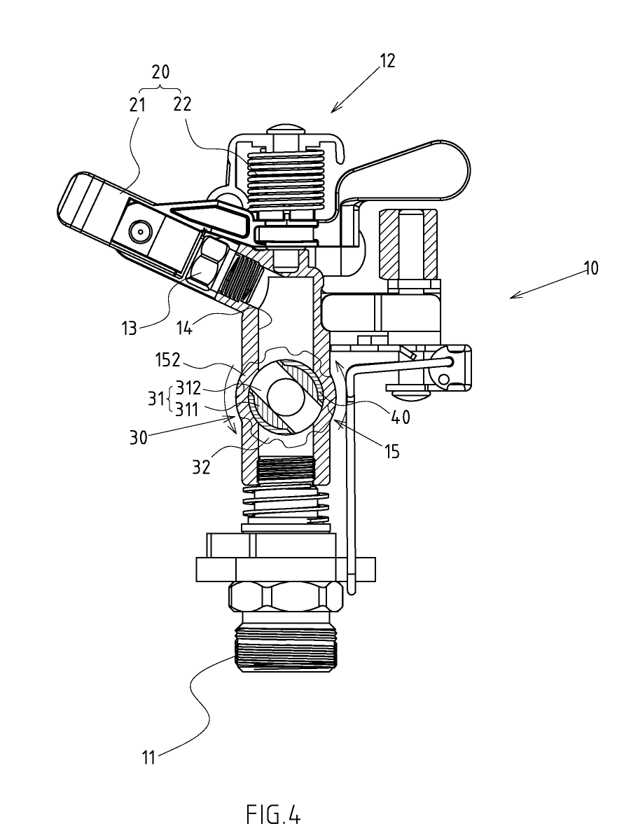

When the sprinkler is used, the users are able to rotate the regulating portion 32 if necessary. As the regulating portion 32 is set at one side of the radial sleeve 311, the radial sleeve 311 could rotate with the regulating portion 32, so the axial water guide hole 312 of said radial sleeve 311 could be used to control the water outflow of the sprinkler. This is due to the fact that, when water is guided from the flow channel 14 within the sprinkler's main body 10, the flow regulating valve 30 must be passed, and biggest outflow of the sprinkler can be realized if the axial water guide hole 312 of the radial sleeve 311 is connected with the flow channel 14 (as shown in FIG. 3). Otherwise, if the regulating portion 32 is rotated in a manner that the axial water guide hole 312 could be covered partially by the inner wall 152 of the regulating valve assembly portion 15, in tune with the rotation angle change of the flow regulating valve 30 (as shown in FIG. 4). As the axial water guide hole 312 is available with different diameters, the users can control randomly the water outflow as if the axial water guide hole 312 is located correspondingly to the flow channel 14.

The inlet tube coupling end 11 of the percussive sprinkler is assembled onto an inlet tube, so water from the inlet tube coupling end 11 firstly flows through the axial water guide hole 312 of the flow regulating valve 30, then into the main body 10, and finally is sprayed out of the sprinkler head 13. In such a case, the water stream will impinge on the hydraulic pusher 21 of the percussive diversion frame 20, so the hydraulic pusher 21 swings outwards, enabling the torsional spring 22 of the percussive diversion frame 20 to generate a torsional restoring force, and the hydraulic pusher 21 to generate a rotary restoring motion for the circular motion of the spraying water stream, thus realizing rotary sprinkling of the percussive sprinkler.

1. A percussive sprinkler with flow regulation functions; comprising:
amain body, at lower end of which an inlet tube coupling end is set, and at upper end of which a top frame is set; and a sprinkler head is protruded forwards close to the lower flange of the top frame; a flow channel is also formed between the inlet tube coupling end and sprinkler head;
a percussive diversion frame, arranged onto the top frame at upper end of the main body; a hydraulic pusher and a torsional spring are arranged at one side of the percussive diversion frame; the hydraulic pusher is located correspondingly with a spacing to the front end of the sprinkler head of the main body; a regulating valve assembly portion, formed onto the preset location of the flow channel of the main body, and comprising of a through-hole and inner wall; said through-hole is connected with the flow channel;
a flow regulating valve, assembled onto the regulating valve assembly portion, and including at least a switching member and a regulating portion; the switching member can be driven to control water flow via the rotation of the regulating portion.

2. The structure defined in claim 1, wherein said flow regulating valve is has a cylindrical shape that can be embedded into the regulating valve assembly portion.

3. The structure defined in claim 1, wherein a sealing valve seat is arranged between the flow regulating valve and regulating valve assembly portion; said sealing valve seat is provided with a penetrated hole corresponding to the flow channel.

4. The structure defined in claim 1, wherein the switching member has a radial sleeve and an axial water guide hole formed on the radial sleeve; the regulating portion is arranged at one side of the radial sleeve; when the regulating portion is rotated, the axial water guide hole on the radial sleeve of said switching member may be covered partially by the inner wall of the regulating valve assembly portion, in tune with the rotation angle change of the flow regulating valve; as the axial water guide hole is available with different diameters, it is possible to control the water outflow.
